(19) United States
(12) Patent Application Publication
(10) Pub. No.: US 2026/0053329 A1
(43) Pub. Date: Feb. 26, 2026

(54) INDUCTION HEATED FAN FOR DISHWASHER

(71) Applicant: Midea Group Co., Ltd., Foshan (CN)

(72) Inventors: Russell D. Dietrich, Louisville, KY (US); Matthew Hunter, Louisville, KY (US)

(73) Assignee: Midea Group Co., Ltd., Foshan (CN)

(21) Appl. No.: 18/815,475

(22) Filed: Aug. 26, 2024

(51) Int. Cl. A47L 15/48; H05B 6/10

(52) U.S. Cl. CPC A47L 15/485; A47L 15/486; H05B 6/10

(57) ABSTRACT

A dishwasher with a dry mode having a wash compartment and a heating unit. The heating unit is used to directly heat fan blades of a fan from outside the wash compartment. The heating unit further includes a fan motor, multiple fan blades, and a wireless power source. The fan motor drives the fan blades. The fan blades are made up of a ferromagnetic material which are fluidly coupled with an atmosphere of the wash compartment. The wireless power source wirelessly induces heating of the ferromagnetic material while the fan blades circulate the atmosphere, and the ferromagnetic material heats the atmosphere of the wash compartment.

### BACKGROUND

This disclosure relates, in general, to a mechanical appliance designed to wash utensils and, not by way of limitation, to control the drying process of a dishwasher, among other things.

A dishwasher is a mechanical appliance designed to wash, rinse, and dry kitchen utensils. In general, the dishwasher includes three functional cycles: a washing cycle, a rinsing cycle, and a drying cycle. The washing cycle utilizes a high-pressure, hot water, and detergent mixture using via rotating sprayers to dislodge food residues and the rinsing cycle employs clean water to eliminate any food and detergent traces. The optional drying cycle concludes the dishwashing process by applying heat to achieve complete dryness.

The drying cycle is energy intensive using heating coils to heat air circulated in the dishwasher. The heating elements have to penetrate into the interior of the dishwasher with various electrical connections. Electrical components in a high-humidity environment are prone to failure.

### SUMMARY

In one embodiment, the present disclosure provides a dishwasher with a dry mode consisting of a wash compartment and a heating unit. The heating unit is used to directly heat fan blades of a fan from outside the wash compartment. The heating unit further consists of a fan motor, multiple fan blades, and a wireless power source. The fan motor derives the fan blades, and the fan blades are made up of a ferromagnetic material which are fluidly coupled with an atmosphere of the wash compartment. The wireless power source wirelessly induces heating of the ferromagnetic material while the fan blades circulate the atmosphere, and the ferromagnetic material heats the atmosphere of the wash compartment.

In an embodiment, a dishwasher with a dry mode consisting of a wash compartment and a heating unit. The heating unit is used to directly heat fan blades of a fan from outside the wash compartment. The heating unit further consists of a fan motor, multiple fan blades, and a wireless power source. The fan motor derives the fan blades, and the fan blades are made up of a ferromagnetic material which are fluidly coupled with an atmosphere of the wash compartment. The wireless power source wirelessly induces heating of the ferromagnetic material while the fan blades circulate the atmosphere, and the ferromagnetic material heats the atmosphere of the wash compartment. The fan blades of a fan are attached to a shaft and the fan is operable to cool down the wireless power source located outside of the wash compartment and to reduce moisture buildup in the dishwasher. The fan blades operate at a low revolution per minute (RPM) and collapse/retract when not in use. The fan blades are divided into different heating zones based on placement of utensils within the dishwasher. Furthermore, the fan blades of the heating unit also rotate during a wash cycle to disperse water within the wash compartment during a wash cycle.

In another embodiment, a drying system for utensils, with a dry mode of a dishwasher consisting of a wash compartment and a heating unit. The heating unit is used to directly heat fan blades of a fan from outside the wash compartment. The heating unit further consists of a fan motor, multiple fan blades, and a wireless power source. The fan motor derives the fan blades, and the fan blades are made up of a ferromagnetic material which are fluidly coupled with an atmosphere of the wash compartment. The wireless power source wirelessly induces heating of the ferromagnetic material while the fan blades circulate the atmosphere, and the ferromagnetic material heats the atmosphere of the wash compartment. The fan blades of a fan are attached to a shaft and the fan is operable to cool down the wireless power source located outside of the wash compartment and to reduce moisture buildup in the dishwasher. The fan blades operate at a low revolution per minute (RPM) and collapse/retract when not in use. The fan blades are divided into different heating zones based on placement of utensils within the dishwasher. Furthermore, the fan blades of the heating unit also rotate during a wash cycle to disperse water within the wash compartment during a wash cycle.

In yet another embodiment, a drying method for utensils, with a dry mode of a dishwasher including directly heating fan blades of a fan from outside a wash compartment via a heating unit. The heating unit further consists of a fan motor, multiple fan blades, and a wireless power source. In one step, the fan motor derives the fan blades, and the fan blades are made up of a ferromagnetic material which are fluidly coupled with an atmosphere of the wash compartment. The wireless power source wirelessly induces heating of the ferromagnetic material while the fan blades circulate the atmosphere, and the ferromagnetic material heats the atmosphere of the wash compartment. The fan blades of a fan are attached to a shaft and the fan is operable to cool down the wireless power source located outside of the wash compartment and to reduce moisture buildup in the dishwasher. The fan blades operate at a low revolution per minute (RPM) and collapse/retract when not in use. The fan blades are divided into different heating zones based on placement of utensils within the dishwasher. Furthermore, the fan blades of the heating unit also rotate during a wash cycle to disperse water within the wash compartment during a wash cycle.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIGS. 1A-1B illustrate a perspective view of a dishwasher with a fitted and a pop-out structure, respectively;

FIGS. 2A-2B illustrate a side cross-sectional view of the dishwasher and a zoomed-in view of a heating unit;

FIG. 3 illustrates a block diagram of the heating unit for induction heating;

FIG. 4 illustrates a block diagram of a heat-flow method used for induction heating;

FIG. 5A illustrates the aerodynamics of an induction-heated fan of the heating unit and its dry-boost function;

FIG. 5B depicts a plastic glass without a drying cycle and with one;

FIGS. 6A-6B illustrate plan views of the induction-heated fan of the heating unit of the dishwasher;

FIG. 7 illustrates a working mechanism of the induction-heated fan for the dishwasher; and

FIG. 8 illustrates a drying cycle of the dishwasher via the induction-heated fan.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

The ensuing description provides preferred exemplary embodiment(s) only, and is not intended to limit the scope, applicability, or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

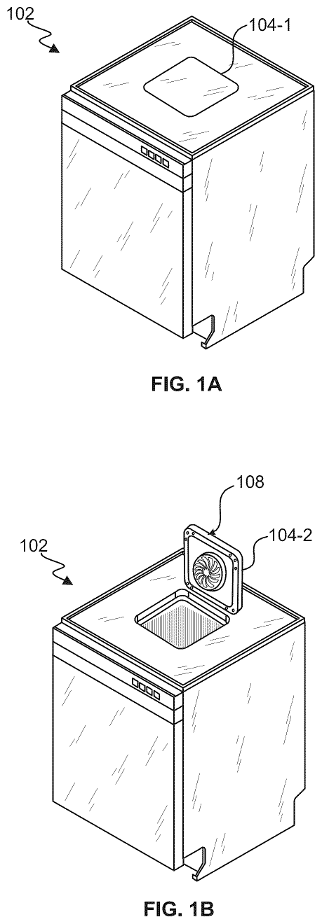

Referring to FIG.1A, a perspective view of an embodiment of a dishwasher 102 with a fitted fan 104-1 is shown. The dishwasher 102 uses inductively heated air circulation and simplifies the task of cleaning utensils by automating the cleaning process with a combination of water, detergent, and heat. The utensils include dishes, pots, pans, cutlery, plastic containers, any kind of beverage-holding utensils, etc. Initially, the dishwasher 102 connects to a home's water supply and draws in hot and cold water which is then further heated to a suitable temperature for cleaning. The machine consists of a detergent dispenser that releases the detergent at the right moment during a wash cycle. Once the dishwasher 102 is started, it begins with a prewash phase where water is sprayed onto the utensils to loosen any food particles. This is followed by a main wash cycle, spraying a hot water and detergent mixture onto the utensils through rotating spray arms, effectively breaking down grease and removing stains. After the main wash cycle, a rinse cycle starts, spraying the utensils with clean water to wash away any remaining detergent.

Some dishwashers also include a rinse aid dispenser that helps to prevent water spots and boost drying. Finally, in a drying cycle, the utensils are either dried using a heating element or left to air dry. Throughout the cleaning process, the sensors of the dishwasher 102 monitor the water's cleanliness, temperature, and level to ensure smooth operation and prevent damages to the utensils or the appliance itself. The design of the dishwasher 102 allows for multiple cycles of spraying, draining, and drying to ensure that the utensils appear clean and sanitized. In this application, a dry mode of the dishwasher 102 uses an induction-heated fan is discussed in detail.

In one embodiment, the dishwasher 102 has a fitted fan 104-1 on the top of the dishwasher 102, and the fitted fan 104-1 is inductively heated to operate during a drying cycle as well as other cycles when heated air circulation is used. The fitted fan 104-1 can be positioned according to the designs of any dishwasher, for example on the back, either side, or bottom of the dishwasher. The fan serves a dual purpose of cooling an induction coil and mitigating moisture buildup in a space between the dishwasher 102 and a cabinet where it is fitted. Unlike traditional methods where fan size is constrained by the space between the cabinet and a dishwasher shell, this embodiment allows for a larger fan size, dictated alone by a space available within a dishwasher cavity. For example, the fan may take up to 75% or 90% of any side of the dishwasher 102. Some embodiments could have multiple fans on the same side or different sides of the dishwasher.

Referring to FIG. 1B, a perspective view of another embodiment of a dishwasher 102 with a pop-out fan 104-2 is shown. This configuration allows for the pop-out fan 104-2 along with a heating unit to be used as a retrofit kit 108. The retrofit kit 108 allows users to upgrade their existing dishwashers with an induction heated fan system to supplement existing drying function or for dishwashers without a drying function. With the pop-out fan 104-2 installed, the dishwasher 102 has an induction heated fan system possibly integrated with existing drying modes, such as traditional heating coils and fans or condensation drying. This hybrid approach allows for a seamless transition and provides flexibility in adapting to different user drying cycle preferences and dishwasher configurations. The dishwasher 102 offers variable settings for temperature control and fan speed. Furthermore, the dishwasher 102 incorporates different cleaning modes for the dishwasher 102 and automatically adjusts the settings for drying results, for example, which racks are loaded, cycle time duration, etc.

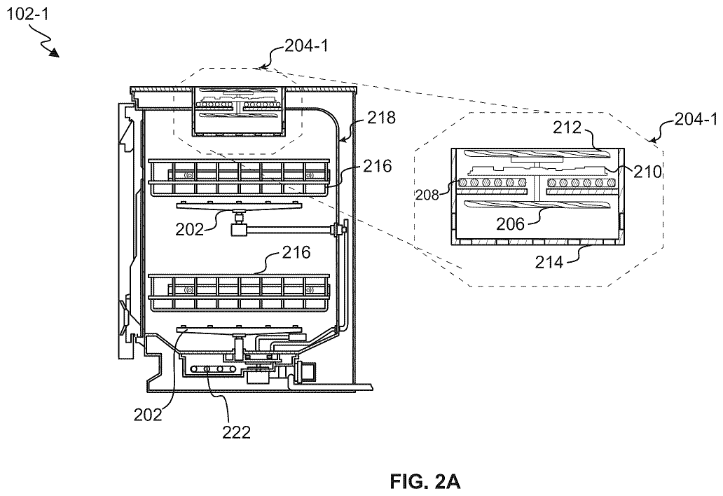

Referring next to FIG.2A, a side cross-sectional view of an embodiment of dishwasher 102-1 with a zoomed-in view of a heating unit 204-1 are shown. The dishwasher 102-1 mainly consists of two components: a wash compartment 218 and the heating unit 204-1 that may be fitted at the time of manufacture or installed in the field as a pop-out retrofit. The wash compartment 218 further includes racks 216 for holding the utensils and spray arms 202 that serve as water jets to rinse the utensils. The wash compartment 218 has multiple racks and spray arms 202 depending upon the design and size of the dishwasher 102. Other components of the dishwasher 102 include controls and monitors, insulation, detergent dispenser, lock, door gasket, access panel, door lock, float valve, water inlet valve, drainpipe, etc. A heater 222 in the bottom of the wash compartment 218 can further heat the water used during washing.

The heating unit 204-1 heats and circulates the air within the wash compartment 218, enhancing the drying processes of the utensils. Circulating hot air through the dishwasher 102 during the drying process not only speeds up the drying process but also helps in killing bacteria on the utensils thus making them more hygienic. The heating unit 204-1 includes heated fan blades 206, an induction coil 208, a fan motor 210, and a cooling fan 212. The heating unit 204-1 also has a fan cover 214 that has air inlet and outlet holes to circulate hot air throughout the wash compartment 218. The heating unit 204-1 includes the induction coil 208 external to wash compartment 218 to avoid exposure to the harsh conditions. Internal placement of a fan with the heated fan blades 206 allows the heating unit 204-1 to directly heat the heated fan blades 206 from outside the wash compartment 218 to avoid electrical circuitry being subjected to the humidity and liquid inside the wash compartment 218. The fan motor 210 is used to drive both the cooling fan 212 and the heated fan blades 206. Both the fan motor 210 and the cooling fan 212 are placed outside the wash compartment 218. The heating unit 204-1 is placed at the top of the wash compartment 218, with some of its components inside the wash compartment 218. However, the size and placement of the heating unit 204-1 can be changed in other embodiments of the dishwasher.

Heated fan blades 206 are made up of a ferromagnetic material and are fluidly coupled with an atmosphere of wash compartment 218. The ferromagnetic material is inductively heated by a wireless power source, specifically, the induction coil 208 to heat the atmosphere while heated fan blades 206 circulate the atmosphere with hot air. Heated fan blades 206 are attached to a shaft made of a non-ferromagnetic material, thus the shaft does not heat up as do the fan blades 206. Heated fan blades 206 reduce moisture in dishwasher 102 during a drying cycle.

The induction coil 208 of the heating unit 204-1 is the wireless power source for heating in the drying mode of the dishwasher 102. The wireless power source or the induction coil 208 is placed outside the wash compartment 218 and is wirelessly inducing heating to the ferromagnetic material of the heated fan blades 206. From here on, the “wireless power source” is referred to as the “induction coil” in this application. By heating the fan blades directly via the induction coil 208, the safety of the dishwasher 102 is also ensured as the wireless power source is placed outside the wash compartment 218. Another advantage is the precision in temperature control achieved using the induction coil 208 to inductively heat the heated fan blades 206. A temperature sensor can provide feedback to modulate the power to the induction coil 208 to maintain the desired temperature for the heated fan blades 206.

The heated fan blades 206 are exposed to the atmosphere of the wash compartment 218 of the dishwasher 102. The heated fan blades 206 work during the drying cycle as well as rotate during the wash cycle of the dishwasher 102 which offers an added advantage. The rotating fan disperses heated air within the wash compartment 218, enhancing the washing process. The fan size is only limited by the size of the dishwasher 102 itself to allow oversized fan in other embodiments. The oversized heated fan blades, operating at low revolutions per minute (RPM), generate less noise compared to smaller fans running at higher RPM.

Referring next to FIG.2B, a side cross-sectional view of the dishwasher 102-2 and zoomed-in view of an embodiment of the heating unit 204-2 are shown. The dishwasher 102-2 has same components as mentioned in previous figure except the heating unit 204-2 does not include the cooling fan 212. Traditionally, ducting fans from external sources are used to provide airflow to cool the motor 210 or they can be passively cooled without airflow. To implement this embodiment of the dishwasher 102, one would need to install a fan with heated blades inside the wash compartment 218, connect it to an external fan motor, and position the induction coil 208 outside the wash compartment 218.

In one embodiment, the heated fan blades 206 of the heating unit 204-2 collapse or retract when not in use. Centrifugal force from the spinning of the motor will extend the heated fan blades from the collapsed position.

Since the fan blades are directly heated by the induction coil 208, this provides a precise control for setting temperature of the fan blades, and the fan speed controls how much of the heat is transferred with the circulating air. There are a few methods to control the temperature of the fan blade. One approach is to use a nearby temperature sensor within 0.5 inch distance from the heated fan blades 206 to control the input to the Ki unit. Additionally, the input to the Ki unit can also be tested and predetermined to achieve different temperatures for specific fan blades. This way, a temperature range is established that the input to the coil 208 achieves and runs the fan and Ki unit at that setpoint for a determined amount of time.

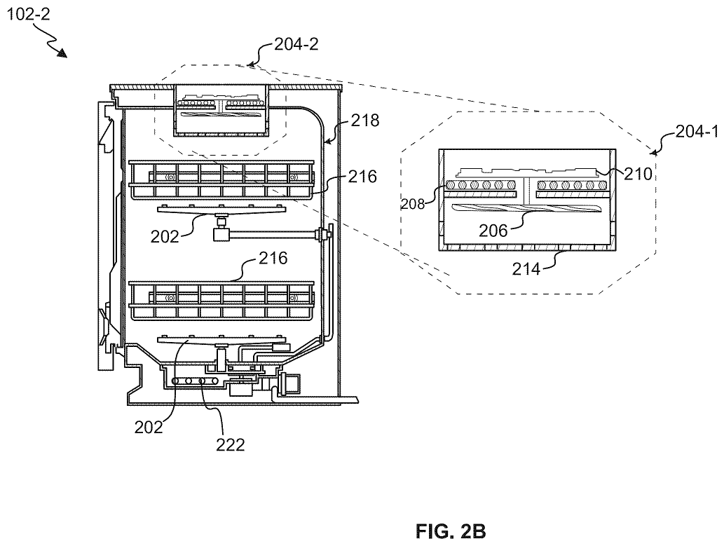

Referring next to FIG. 3, a block diagram 300 of the heating unit 204-1 for induction heating is shown. The block diagram 300 refers to a process that heats electrically conductive materials, such as metals or other ferromagnetic materials, through electromagnetic induction. The electromagnetic induction involves generating an electromagnetic field within a coil 208, which in turn induces eddy currents within the conductive materials. The electromagnetic induction creates an electromotive force (emf) across an electrical conductor in a changing magnetic field. The electromotive force (emf) induces an electrical current in the electrical conductor by changing strength where the electrical conductor is stationary; or by moving the electrical conductor through a stationary electromagnetic field. The block diagram 300 of the heating unit 204-1 for induction heating includes a power supply 302, a matching 304, and a tank circuit 306.

The power supply 302 derives input power from an alternating current (AC) power and performs several tasks such as converting the AC power to a direct current (DC) output suitable for a load circuit and ensuring no AC contamination. The power supply 302 self-regulates to provide a steady DC voltage despite fluctuations in the AC power, load current, or temperature. The power supply 302 further consists of a rectifier 308 and an inverter 310.

The rectifier 308 is the main unit of power supply 302 and converts the AC power to a pulsating DC voltage. In an embodiment, the rectifier 308 is a half-wave rectifier, allowing one half of an AC cycle to pass through and blocking the other half cycle. Half-wave rectification entails three main components: a transformer, a diode, and a resistive load. In the half-wave rectifier configuration, the diode functions as a unidirectional conductor selectively permitting only one half of the AC cycle to traverse through, thereby establishing a consistent directionality of current flow within the circuit.

In another embodiment, the rectifier 308 can be a full-wave rectifier or a full-wave bridge rectifier. The full-wave rectifier converts both halves of the AC cycle into a DC voltage and uses multiple diodes for its operation. The full-wave bridge rectifier also converts both halves of the AC cycle into the DC voltage and uses four or more diodes in a bridge configuration. In other embodiments, the rectifier 308 can be a three-phase full-wave diode rectifier. The three-phase full-wave diode rectifier converts three-phase AC power (shown as L1, L2 and L3) into DC power using six diodes in a full-wave bridge configuration, with pair of diodes conducting 120 degrees of the AC cycle. The three-phase full-wave diode rectifier results in a smoother and more continuous DC output compared to a single-phase rectifier.

The rectifier 308 has two output lines: a +VR and a −VR. The +VR output of the rectifier 308 emerges from a junction where the anodes of the diodes from a positive half of the bridge configuration meet. The +VR output carries the positive half-cycles of the three-phase AC input after they have been rectified. The −VR output of the rectifier 308 comes from a junction of the cathodes of the diodes from a negative half of the bridge configuration. The −VR output carries the negative half-cycles, which have been inverted to contribute to a positive DC voltage. Together, the +VR and the −VR lines provide a continuous DC voltage that is typically smooth due to the overlapping of the phases, which results in less fluctuation and more consistent voltage levels.

The inverter 310 takes the +VR and the −VR at its input terminals and produces an alternating current at its output terminals. The DC voltage from the rectifier 308 is fed to the inverter 310 that converts the DC voltage back into an AC voltage. The inverter 310 does so by switching a DC current on and off at a high frequency, creating a waveform that closely resembles the AC voltage. This process uses power electronics switches, such as MOSFETs or IGBTs, to mimic the changing direction of an AC current. In one embodiment, the inverter 310 is in a half-bridge or a full-bridge configuration, corresponding to a single-phase inverter design. In other embodiments, the inverter 310 can be based on a 120-degree mode of conduction or a 180-degree mode of conduction, corresponding to a three-phase inverter design.

The combination of the rectifier 308 and the inverter 310 in the power supply 302

isolates the load from power quality issues such as voltage spikes, dips, and frequency variations. The combination of the rectifier 308 and the inverter 310 in the power supply 302 also maintains power specifications and offers continuous supply, optimizing performance for appliances, in this specific case, for the dishwasher 102.

The matching 304 provides an electrical network designed to optimize the power transfer between a source: the power supply 302, and a load: the tank circuit 306. The matching 304 ensures that the input impedance of the tank circuit 306 matches the output impedance of the power supply 302 and the possible signal reflections are reduced. In one embodiment of present disclosure, the matching 304 is composed of properly proportioned transmission lines. In other embodiments, the matching 304 can be an adjustable network of inductors, capacitors and/or resistors. The matching 304 with an adjustable inductor allows for the adjustment of its inductance, to fine-tune the impedance matching of the circuit. For induction heating during the drying cycle of the dishwasher 102, the matching 304 provides precise impedance control and ensures maximum power transfer and minimizes the signal reflection.

The tank circuit 306 is a combination of an inductor L and a capacitor C. The capacitor C is an electrical component containing two conductive plates. These conductive plates are isolated through a dielectric or a non-conductive material. The capacitor C stores electrical energy or charges in an electric field created between the conductive plates when a voltage is applied. The inductor L is typically a coil, capable of storing magnetic energy in the surrounding magnetic field created by the flow of current through it. For the tank circuit 306, the capacitor C and the inductor L are connected by conducting wires, using magnetic resonance to store electrical energy oscillations. As the capacitor C charges up, the inductor L draws in these charges, which are delivered through the conducting wires. The back-and-forth movements of the charges between the capacitor C and the inductor L create resonance, a phenomenon of generating electrical oscillations of a desired frequency. The energy oscillates between an electric field storing component, the capacitor C, and a magnetic energy storing component, the inductor L. When the charge of the inductor L exceeds that of the charge of the capacitor C, the electromagnetic field of the coil starts to weaken. However, energy continues to flow back to the capacitor C through the conducting wires. This cycle keeps going until the circuit's energy is fully used up as resistance. The tank circuit 306 transfers a heating power from the power supply 302 to its load and minimizes power loss. For the induction heating during the drying cycle of the dishwasher 102, the energy accumulation in the tank circuit 306 results in a stronger current, which in turn supplies more energy for the induction heating process.

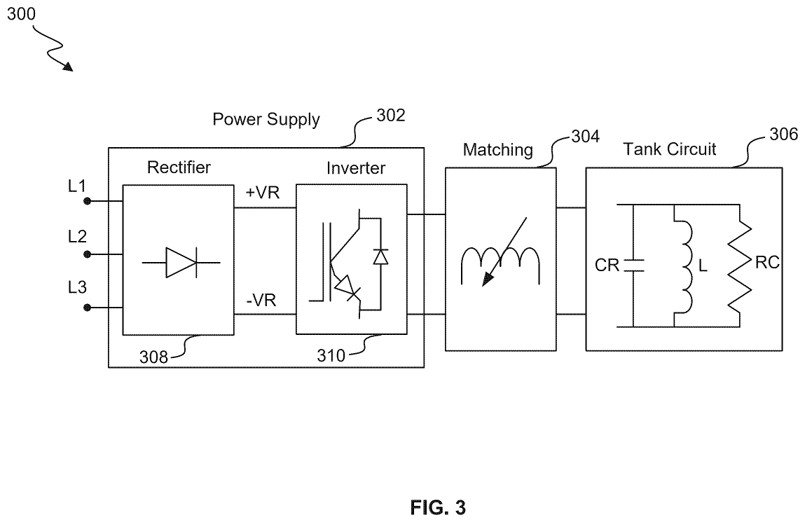

Referring next to FIG. 4, a block diagram of an embodiment of a heat-flow method 400 used for the induction heating is shown. The heat-flow method 400 explains the movement of heat energy in the wash compartment 218 of the dishwasher 102. The heat-flow method 400 includes the fan motor 210, the power supply 302, the induction coil 208, and the heated fan blades 206.

The heated fan blades 206 are placed inside the wash compartment 218 and are composed of a ferromagnetic material. The placement of the heated fan blades 206 can be adjusted inside the wash compartment 218 as per the design feature of the dishwasher 102 to integrate into any side of the dishwasher 102 with apertures to fluidly communicate with the wash compartment 218 for circulating air and/or heating that air. For example, the heated fan blades 206 can either be placed on the top or at the bottom of the wash compartment 218. In both cases, the heated fan blades 206 function in a closed environment and keep heat-flow evenly distributed within the dishwasher 102. In some embodiments, there are multiple heating units 204 that work in concert to provide the specified drying function.

The power supply 302 is coupled with the fan motor 210 and the induction coil 208. The power supply 302 energizes the fan motor 210 by providing electrical energy to which the fan motor 210 converts into mechanical energy. The power supply 302 provides a steady flow of electrical energy to the fan motor 210. In an embodiment, the electrical energy delivered to the fan motor 210 by the power supply 302 is in the form of a direct current (DC). In another embodiment, the electrical energy delivered to the fan motor 210 by the power supply 302 can be in the form of an alternating current (AC). The choice between the DC and the AC depends on the type of the fan motor 210 used in the embodiment. The electrical energy delivered by the power supply 302 to the fan motor 210 generates a magnetic field in the windings of the fan motor 210. The magnetic field interacts with the electromagnetic field/permanent magnets of the fan motor 210 and causes the rotor of the fan motor 210 to turn. The movement of the rotor of the fan motor 210 drives the shaft of the fan motor 210, powering the load and converting the electrical energy into mechanical energy.

The power supply 302 energizes the induction coil 208 and delivers a high frequency alternating current (AC) to the induction coil 208. The current flowing through the induction coil 208 creates an electromagnetic field around it which induces eddy currents in the ferromagnetic material placed within and/or near to the induction coil 208, i.e., the heated fan blades 206. The eddy currents are loops of the electrical current induced within the induction coil 208 by a fluctuating magnetic field, causing electric flow in the induction coil 208 to swirl in circular patterns. As the eddy currents flow through the induction coil 208, they encounter resistance and result in heat generation due to current-resistance losses. The generated heat in the surrounding of/within the induction coil 208 is the induction heating, used to rotate the fan blades for circulating hot air through the wash compartment 218.

The fan motor 210 drives the heated fan blades 206, positioned inside the wash compartment 218. The rotor of the fan motor 210 is connected to the fan through the shaft. As the rotor of the fan motor 210 spins, it turns the heated fan blades 206 through the shaft and creates an airflow. The induction heating, resulting from an interaction between the power supply 302 and the induction coil 208 heats up the ferromagnetic material of the heated fan blades 206. The heat transferred by the induction coil 208 to the ferromagnetic material of the heated fan blades 206 and the fan rotation through the fan motor 210 circulates hot air inside the wash compartment 218 of the dishwasher 102.

In an embodiment, the induction heating induced in the heated fan blades 206 by the induction coil 208 can be adjusted to achieve different heating zones to allow localized heating where there are multiple heating units 204 or air flow diversion mechanisms. The adjustable frequency of the alternating current (AC) delivered by the power supply 302 changes the fluctuation levels of the magnetic field within the induction coil 208 and results in adjustable/controllable heating zones. The alteration of the eddy currents by modifying the power levels of the power supply 302 can also provide variable heating.

In other embodiments, to further control the induction heating and to create heating zones as per the requirements of the user, for example, the proximity of the induction coil 208 and the heated fan blades 206 along with blade size can be adjusted during design. The distance between the induction coil 208 and the heated fan blades 206 directly affects the strength of the induction heating and hence is adjusted to achieve a precise temperature/heat-flow control. The speed of the heated fan blades 206 is controlled by adjusting the frequency and the voltage supplied to the fan motor 210 by the power supply 302. In some embodiments, some fan blades can be ferromagnetic while others are not to adjust the heat transfer in the design.

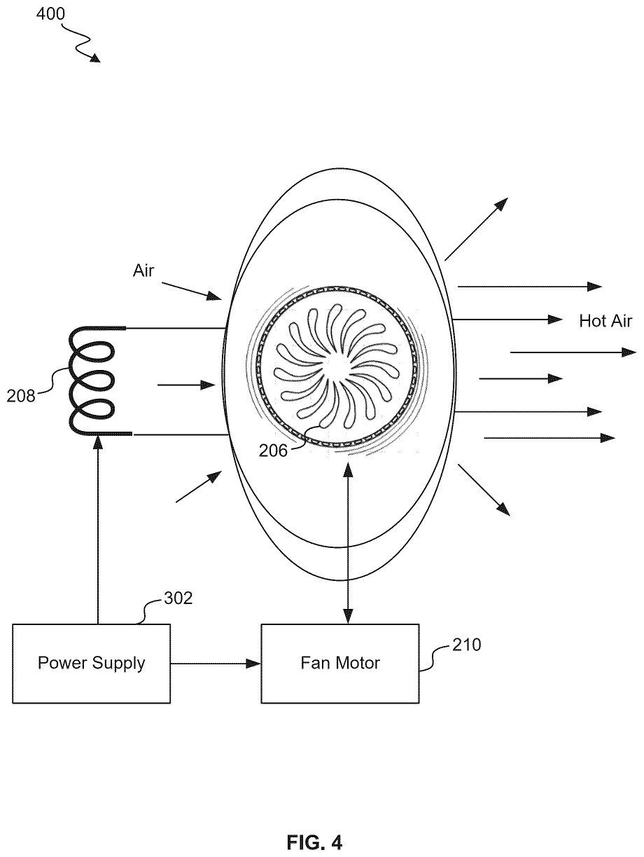

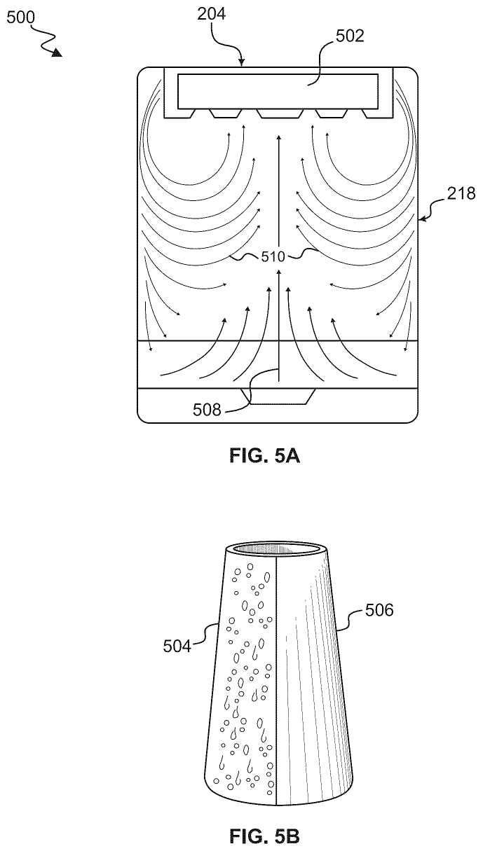

Referring next to FIG.5A, an aerodynamics flow diagram 500 of an induction heated fan 502 of the heating unit 204 and its dry-boost function for an embodiment is shown. The induction heated fan 502 circulates hot air in the atmosphere of the wash compartment 218 using the heated fan blades 206. The heated fan blades 206 of the dishwasher 102 are directly heated by the induction coil 208 placed outside the wash compartment 218. The induction heated fan 502 has the fan cover 214 that has different air inlets and outlets to direct airflow. At section 510, the hot air is dispersed in the dishwasher 102 via the heated fan blades 206. The hot air goes out from the air outlets on various sides of the fan cover 214, thus creating a circular flow pattern within the dishwasher 102. This makes the hot air reach the utensils placed in different racks of the wash compartment 218. At section 508, the cooler air circulates back to the heated fan blades 206 after passing through the center of the wash compartment 218. In this way, the air of the atmosphere of the wash compartment 218 is circulated during the drying cycle. Once the utensils get thoroughly dried, the heated fan blades 206 are turned off and the air circulation within the dishwasher 102 stops.

The dry-boost function of the induction heated fan 502 de-humidifies the utensils and internal atmosphere of the wash compartment 218 as water accumulates at the bottom of the dishwasher before being drained. After the drying cycle, an additional step is performed to blow the unheated air into the wash compartment 218 via the induction heated fan 502.

Referring next to FIG. 5B, a plastic glass without a drying cycle and with one is depicted to show water spots where drying was not performed. Water drops and condensation on dishes 504 will create water spots after unaided drying that are unsightly. The side with water spots shows half 504 of a plastic glass dried without using the drying cycle of a traditional dishwasher 102. Here, the glass is an exemplary utensil shown for sake of understanding, but all silverware, cups and dishes can suffer from unsightly water spots. In contrast the half 506 of the glass that used a drying cycle 506 is fully dried using the dry-boost function of the heated induction fan 502 of the dishwasher 102 to avoid water spots or moisture when unloading the dishwasher 102.

An initial prototype of the dishwasher 102 that dries the utensils via induction heated fan blades showed considerably better results than a normal dishwasher. As an example, a baseline performance of an ordinary dishwasher with respect to its unit dry and dish dry performances is shown in Table I below:

TABLE I

| | | |
|---|---|---|
| Pre-Cycle | Post Cycle | |
| Weight (g) | Weight (g) | Delta |

Unit Dry Performance _ Baseline

| | | | | |
|---|---|---|---|---|
| Unit | Silverware Basket | 349.53 | 359.86 | 10.33 |
| | Wipe Down Towel | 183.61 | 185.73 | 2.12 |
| | | | Total Unit | 12.45 |
| | | | Water (g) | |

Dish Dry Performance _ Baseline

| | | | | |
|---|---|---|---|---|
| Dishes | Short Plastic Cup | 251.08 | 255.05 | 3.97 |
| | Tall Plastic Cup | 622.62 | 625.06 | 2.44 |
| | Small Plastic Bowl | 225.86 | 226.45 | 0.59 |
| | | | Total Dishes | 7.00 |
| | | | Water (g) | |

On the other hand, the unit dry and dish dry performances of the dishwasher 102 with the induction heated fan 502 is shown below in Table II:

TABLE II

| | | |
|---|---|---|
| Pre-Cycle | Post Cycle | |
| Weight (g) | Weight (g) | Delta |

Unit Dry Performance _ Induction Prototype

| | | | | |
|---|---|---|---|---|
| Unit | Silverware Basket | 349.53 | 351.71 | 2.18 |
| | Wipe Down Towel | 185.66 | 186.97 | 1.31 |
| | | | Total Unit | 3.49 |
| | | | Water (g) | |

Dish Dry Performance _ Induction Prototype

| | | | | |
|---|---|---|---|---|
| Dishes | Short Plastic Cup | 251.08 | 252.92 | 1.84 |
| | Tall Plastic Cup | 622.62 | 622.94 | 0.32 |
| | Small Plastic Bowl | 225.86 | 225.81 | −0.05 |
| | | | Total Dishes | 2.11 |
| | | | Water (g) | |

From Table I, the baseline run is 12.45/7.00, where a dishwasher employed its standard drying system. Whereas in Table II, a significant improvement: 3.49/2.11 is achieved by utilizing the air dryer set to 95° C. (203° F.) for the same duration as the standard dry cycle. Notably, the induction coil 208 of the dishwasher 102 was intentionally disconnected during the air dryer operation. This shows that the drying cycle of the dishwasher 102 with the induction heated fan 502 gives far better performance than a regular dishwasher and consumes less energy.

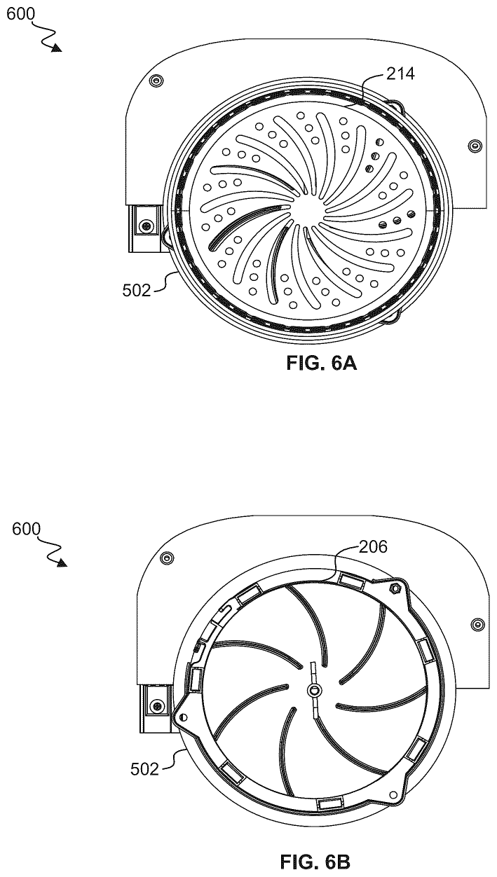

Referring next to FIGS. 6A & 6B, plan views 600 of embodiments of the induction heated fan 502 of the heating unit 204 of the dishwasher 102 are shown. The induction heated fan 502 has a fan cover 214 with multiple holes showing air inlets and outlets shown in FIG. 6A, but removed in FIG. 6B. Underneath the fan cover 214 are the heated fan blades 206 which circulate the atmosphere of the wash compartment 218. The heated fan blades 206 rotate not only during the drying cycle but can optionally run during the wash cycle of the dishwasher 102. During the wash cycle, the heated fan blades 206 rotate to disperse air, water and/or heat through the wash compartment 218 for thorough cleaning. During the drying cycle, the heated fan blades 206, which are heated by the induction coil 208 when circulating hot air to dry out the utensils. This way of heating the fan blades not only saves energy but also reduces the drying period, prevents water spots, and gives precise fan speed and temperature controls.

The heated fan blades 206 may be rotated at a low RPM with a larger fan resulting in a quieter operational environment as compared to traditional dishwashers with smaller circulation fans. The size of the induction heated fan 502 is larger as compared to the commonly used fans in traditional dishwashers. Since the induction heated fan 502 is installed inside the wash compartment 218, the size of the induction heated fan 502 is only constrained by the space available within the wash compartment 218. In one embodiment, the induction heated fan 502 is used as a retrofit kit that allows a user to upgrade an existing dishwasher with induction heating by simply attaching induction heated fan 502 in the field after manufacture. In another embodiment, the heated fan blades 206 collapse/retract when not in use or might have multiple heated fans 502 or baffles to direct heated airflow into different heating zones within the dishwasher 102.

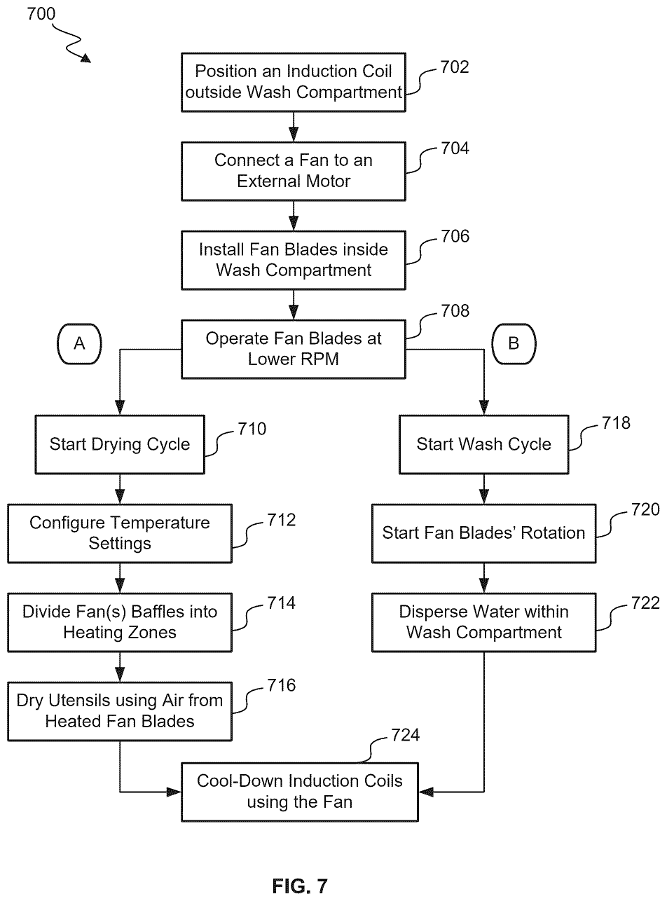

Referring next to FIG.7, an embodiment of a working mechanism 700 for the induction heated fan 502 for the dishwasher 102 is shown. The working mechanism 700 emphasizes a dry mode of the dishwasher 102 which is being inductively heated by a wireless power source i.c., the induction coil 208. At block 702, the induction coil 208 is placed outside the wash compartment 218 of the dishwasher 102. This provides extra safety as the wireless power source has no contact with a wet area of the dishwasher 102. The induction coil 208 or the wireless power source is wirelessly inducing heating in the ferromagnetic material of the fan blades. By heating the fan blades directly via the induction coil 208, the heat transfer efficiency of the dishwasher 102 is greatly improved which results in faster drying of utensils.

At block 704, the induction heated fan 502 is connected to the fan motor 210 which is placed outside the wash compartment 218. The fan motor 210 is a part of the heating unit 204-1 of the dishwasher 102 and drives the heated fan blades 206 of the induction heated fan 502.

At block 706, the heated fan blades 206 of the induction heated fan 502 are installed inside the wash compartment 218. The heated fan blades 206 are made up of a ferromagnetic material, fluidly coupled with an atmosphere of the wash compartment 218. The ferromagnetic material is inductively heated by a wireless power source/the induction coil 208 and heats the atmosphere while the heated fan blades 206 circulate the atmosphere with hot air. The heated fan blades 206 are attached to a shaft made of a non-ferromagnetic material, thus the shaft does not heat up with the fan blades. Furthermore, the heated fan blades 206 can retract or collapse when not in use.

At block 708, the heated fan blades 206 are operated optionally at a low RPM which contributes to a quieter operational environment. The larger fan blades, operating at lower revolutions per minute (RPM), generate less noise compared to smaller fan blades running at high speeds. The heated fan blades 206 are used not only for the drying cycle of the dishwasher 102, but can optionally be used during its wash cycle too.

At block 710, the dishwasher 102 with a dry mode starts the drying cycle and configures the temperature settings at block 712. Since the fan blades are directly heated by the induction coil 208, this provides a precise control for setting temperature and fan speed of the dishwasher 102. There are a few methods to control the temperature of the fan blade. One approach is by providing a temperature sensor within 0.5 inch radius of heated fan blades 206 to control an input to a KI unit. Additionally, the input to the KI unit can also be tested and predetermined to achieve different temperatures for specific fan blades. This way, a temperature range is established that the input achieves and runs the fan and KI unit at that setpoint for a determined amount of time.

At block 714, the atmosphere of the wash compartment 218 is divided into different heating zones by shifting multiple fans and/or redirecting airflow. The utensils placed in the rack closer to the induction heated fan 502 are in a high temperature zone and vice versa. This allows the user for localized heating and better drying results.

At block 716, the hot air is circulated through the atmosphere of the wash compartment 218 and the utensils placed inside are dried out using air from the heated fan blades 206. This includes the dry-boost function of the dishwasher 102 which de-humifies the utensils and ensures that the utensils are thoroughly dried out without any moisture remaining on them.

The heated fan blades 206 are not only functional during the dry mode, but also during the wash cycle of the dishwasher 102. At block 718, the dishwasher 102 starts its wash cycle, during which the utensils are sprayed with water, cleaned with a detergent, and then rinsed.

At block 720, the heating unit 204-1 starts the rotation of the heated fan blades 206 and water is dispersed within the wash compartment 218 at block 722. In addition to dispersing water onto dirty utensils during the wash cycle, the heated fan blades 206 also help in cooling down the induction coil 208.

Finally at block 724, the induction heated fan 502 is used to cool down the induction coil 208. Thus, the heated fan blades 206 of the heating unit 204-1 serve a dual purpose of cooling down the wireless power source placed outside the wash compartment 218 and reducing moisture buildup in the dishwasher 102.

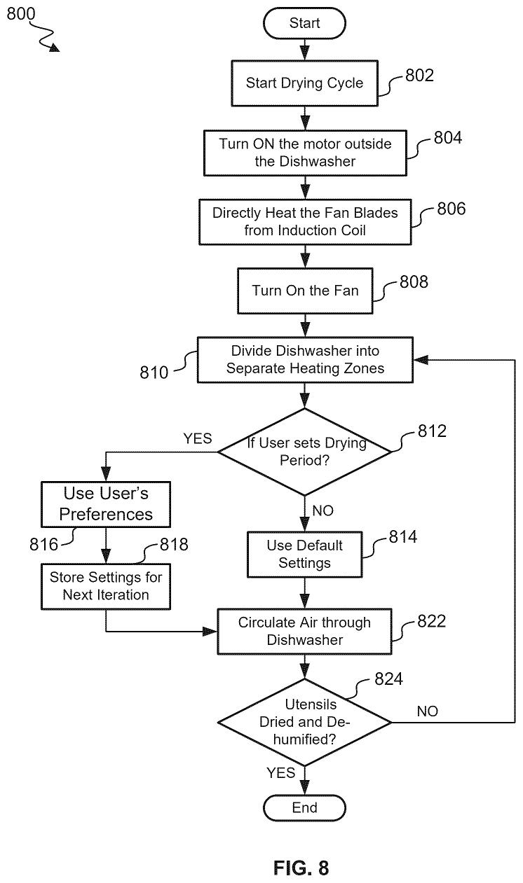

Referring next to FIG. 8, an embodiment of a drying cycle 800 of the dishwasher 102 via the induction heated fan 502 is shown. The depicted portion of the process begins at block 802 where the dishwasher 102 starts its drying cycle. The drying cycle 800 is initiated after the dishwasher 102 is done with its wash cycle or it can be started separately without going through the wash cycle.

At block 804, the fan motor 210 is turned ON. The fan motor 210 is located outside the wash compartment 218 and drives the induction heated fan 502 of the heating unit 204-1. The wireless power source or the induction coil 208 is connected to the power supply 302 located outside the dishwasher 102.

At block 806, the fan blades of the induction heated fan 502 are directly heated from outside the wash compartment 218 using a wireless power source. Here, the wireless power source is the induction coil 208 that is wirelessly inducing heating into the ferromagnetic material of the induction heated fan 502.

At block 808, the induction heated fan 502 is turned ON. The induction heated fan 502 has heated fan blades 206 that circulates the atmosphere of the wash compartment 218, and the ferromagnetic material of the heated fan blades 206 heats the atmosphere. The induction heated fan 502 has a shaft made of a non-ferromagnetic material and does not heat up along with the fan blades.

At block 810, the dishwasher 102 divides the wash compartment 218 into separate heating zones. This means that the utensils placed in the rack closer to the induction heated fan 502 are in the high temperature zone and vice versa. This allows the user to achieve localized heating and better drying results.

At block 812, the dishwasher 102 checks whether the user has set a personalized drying period or not. If the user has set the personalized drying period, the drying cycle 800 uses user's preferences at block 816. However, if the user has not set any drying period, the dishwasher 102 uses its default settings at block 814.

At block 818, the dishwasher 102 stores the user's preferences for the next iteration. After configuring the time period for the drying cycle 800, the heated fan blades 206 circulate air through the wash compartment 218 of the dishwasher 102 at block 822. At block 824, different sensors placed inside the dishwasher 102 check whether the utensils are thoroughly dried and de- humidified. To de-humidify the utensils, the dry-boost function of the dishwasher 102 is used.

If the utensils are still wet or moist, the drying cycle 800 is restarted by dividing the wash compartment 218 into different heating zones. On the other hand, if the utensils are dried and de-humidified at block 824, then the drying cycle 800 comes to an end.

Specific details are given in the above description to provide a thorough understanding of the embodiments. However, it is understood that the embodiments may be practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Implementation of the techniques, blocks, steps and means described above may be done in various ways. For example, these techniques, blocks, steps and means may be implemented in hardware, software, or a combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments may be described as a process that is depicted as a flowchart, a flow diagram, a swim diagram, a data flow diagram, a structure diagram, or a block diagram. Although a depiction may describe the operations as a sequential process, many of the operations can be performed in parallel or concurrently. In addition, the order of the operations may be re-arranged. A process is terminated when its operations are completed but could have additional steps not included in the figure. A process may correspond to a method, a function, a procedure, a subroutine, a subprogram, etc. When a process corresponds to a function, its termination corresponds to a return of the function to the calling function or the main function.

Furthermore, embodiments may be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks may be stored in a machine-readable medium such as a storage medium. A code segment or machine- executable instruction may represent a procedure, a function, a subprogram, a program, a routine, a subroutine, a module, a software package, a script, a class, or any combination of instructions, data structures, and/or program statements. A code segment may be coupled to another code segment or a hardware circuit by passing and/or receiving information, data, arguments, parameters, and/or memory contents. Information, arguments, parameters, data, etc. may be passed, forwarded, or transmitted via any suitable means including memory sharing, message passing, token passing, network transmission, etc.

For a firmware and/or software implementation, the methodologies may be implemented with modules (c.g., procedures, functions, and so on) that perform the functions described herein. Any machine-readable medium tangibly embodying instructions may be used in implementing the methodologies described herein. For example, software codes may be stored in a memory. Memory may be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” may represent one or more memories for storing data, including read-only memory (ROM), random access memory (RAM), magnetic RAM, core memory, magnetic disk storage mediums, optical storage mediums, flash memory devices and/or other machine-readable mediums for storing information. The term “machine-readable medium” includes but is not limited to portable or fixed storage devices, optical storage devices, and/or various other storage mediums capable of storing that contain or carry instruction(s) and/or data.

While the principles of the disclosure have been described above in connection with specific apparatuses and methods, it is to be clearly understood that this description is made only by way of example and not as a limitation on the scope of the disclosure.

We claim:

1. A dishwasher with a dry mode, the dishwasher comprises:
a wash compartment; and
a heating unit to directly heat a plurality of fan blades from outside the wash compartment, wherein the heating unit comprises:
a fan motor;
the plurality of fan blades made of a ferromagnetic material, fluidly coupled with an atmosphere of the wash compartment, wherein:
the plurality of fan blades circulates the atmosphere, and
the ferromagnetic material heats the atmosphere; and
a wireless power source wirelessly inducing heating of the ferromagnetic material from outside of the wash compartment.

2. The dishwasher with the dry mode of claim 1, wherein the plurality of fan blades of a fan is attached to a shaft and the fan is operable to:
cool down the wireless power source located outside of the wash compartment; and
reduce moisture buildup in the dishwasher.

3. The dishwasher with the dry mode of claim 1, wherein the heating unit of the dishwasher is used as a retrofit kit that allows a user to upgrade an existing dishwasher with induction heating.

4. The dishwasher with the dry mode of claim 1, wherein the plurality of fan blades is operated at a low revolution per minute (RPM).

5. The dishwasher with the dry mode of claim 1, wherein the plurality of fan blades of the heating unit collapse or retract when not in use.

6. The dishwasher with the dry mode of claim 1, wherein the plurality of fan blades of the heating unit rotates during a wash cycle to disperse water within the wash compartment during the wash cycle.

7. The dishwasher with the dry mode of claim 1, wherein the plurality of fan blades is divided into a plurality of heating zones based on placement of a plurality of utensils within the dishwasher.

8. A drying system for drying a plurality of utensils with a dry mode of a dishwasher, the drying system comprises:
a wash compartment; and
a heating unit to directly heat a plurality of fan blades from outside the wash compartment, wherein the heating unit comprises:
a fan motor;
the plurality of fan blades made of a ferromagnetic material, fluidly coupled with an atmosphere of the wash compartment, wherein:
the plurality of fan blades circulates the atmosphere, and
the ferromagnetic material heats the atmosphere; and
a wireless power source wirelessly inducing heating of the ferromagnetic material from outside of the wash compartment.

9. The drying system of claim 8, wherein the plurality of fan blades of a fan is attached to a shaft and the fan is operable to:
cool down the wireless power source located outside of the wash compartment; and
reduce moisture buildup in the dishwasher.

10. The drying system of claim 8, wherein the heating unit of the dishwasher is used as a retrofit kit that allows a user to upgrade an existing dishwasher with induction heating.

11. The drying system of claim 8, wherein the plurality of fan blades is operated at a low revolution per minute (RPM).

12. The drying system of claim 8, wherein the plurality of fan blades of the heating unit collapse or retract when not in use.

13. The drying system of claim 8, wherein the plurality of fan blades of the heating unit rotates during a wash cycle to disperse water within the wash compartment during the wash cycle.

14. The drying system of claim 8, wherein the plurality of fan blades is divided into a plurality of heating zones based on placement of the plurality of utensils within the dishwasher.

15. A drying method for drying a plurality of utensils with a dry mode of a dishwasher, the drying method comprising:
directly heating a plurality of fan blades of a heating unit from outside of a wash compartment, wherein the heating unit comprises:
a fan motor;
the plurality of fan blades made of a ferromagnetic material, fluidly coupled with an atmosphere of the wash compartment, wherein:
the plurality of fan blades circulates the atmosphere, and
the ferromagnetic material heats the atmosphere; and
a wireless power source wirelessly inducing heating of the ferromagnetic material.

16. The drying method of claim 15, wherein the plurality of fan blades of a fan is attached to a shaft and the fan is operable for:
cooling down the wireless power source located outside of the wash compartment; and
reducing moisture buildup in the dishwasher.

17. The drying method of claim 15, wherein the plurality of fan blades is operated at a low revolution per minute (RPM).

18. The drying method of claim 15, wherein the plurality of fan blades of the heating unit collapse or retract when not in use.

19. The drying method of claim 15, wherein the plurality of fan blades of the heating unit rotates during a wash cycle to disperse water within the wash compartment during the wash cycle.

20. The drying method of claim 15, wherein the plurality of fan blades is divided into a plurality of heating zones based on placement of the plurality of utensils within the dishwasher.
